(19) United States
(12) Patent Application Publication
(10) Pub. No.: US 2026/0309542 A1
(43) Pub. Date: Oct. 8, 2026

(54) OPTICAL CRA DETECTOR UNIT, MULTISPECTRAL SENSOR SYSTEM, AND METHOD FOR LIGHT SENSING

(71) Applicant: AMS-OSRAM AG, Premstaetten (AT)

(72) Inventor: Gunter SIESS, Kraftsdorf (DE)

(21) Appl. No.: 19/481,538

(22) PCT Filed: Apr. 18, 2024
(86) PCT No.: PCT/EP2024/060491

§ 371 Date: Nov. 5, 2025

(30) Foreign Application Priority Data
May 11, 2023 (DE) 10 2023 112 551.6

(51) Int. Cl. G01J 1/02; G01J 1/42

(52) U.S. Cl. CPC G01J 1/0242; G01J 1/4204

(57) ABSTRACT

A multispectral sensor system is disclosed that provides an ambient light sensor that compensates for potential tilt or misorientation. A dedicated optical chief ray angle detector unit is provided comprising an optical sensor arranged in a chamber with an aperture in a housing, wherein the optical sensor comprises a number of chief ray angle detector pixels having the same spectral sensitivity, each generating an irradiance sensor signal, and wherein the irradiance sensor signals generated by the chief ray angle detector pixels are provided for generation of a parameter characteristic for the chief ray angle of the irradiance of the detector unit.

### TECHNICAL BACKGROUND OF THE INVENTION

The invention relates to an optical CRA detector unit. The invention more particularly relates to an optical CRA detector unit comprising an optical sensor arranged in an optical chamber with an aperture in a housing, said optical sensor arranged to detect received photons through the aperture, and a measurement unit configured to provide sensor signals generated by the optical sensor. The invention furthermore relates to a multispectral sensor system comprising such an optical detector unit, and to a method for multispectral light sensing.

### BACKGROUND

Optical sensors are increasingly being used in various areas of technology as smart phones and mobile devices, smart homes and buildings, industrial automation, medical technology and connected vehicles, etc. At the same time sensor data becomes more complex and is expected to meet the requirements for high accuracy. Further, color and spectral light sensing on a chip-scale have various applications in color identification, data authentication, spectroscopy, and other industrial and consumer-level optical detection applications. In a number of important applications, in particular for camera applications, such sensors are used as ambient light sensors for so-called “auto white balance” functionality, in order to provide essential background information for appropriate correction functionalities and thereby in general improve imaging quality.

Common multispectral sensors are often based on an array of pixels and on-pixel filters for each pixel. For spectroscopic applications the filters can be chosen to have linear independent filter characteristics. In order to accomplish an accurate spectral measurement of a given source, incoming radiation should be known in order to compensate for different response of individual pixels. This way an amplitude of a spectral signal of a pixel can be used to calculate a spectral reconstruction of a light source under study.

However, a homogenous distribution of incoming radiation on the pixel array is an ideal condition. In particular for uses in ambient light sensor devices, homogeneity of incoming light distribution may be of special significance, and in order to provide highly reliable homogenous distribution, diffusers may be used in a position before incoming radiation reaches the pixels in order to mix the incoming light as well as possible and to pass on the light to the sensor array in a homogenous, ideally in a Lambertian, manner. Further, the spectral sensitivity of an interference filter-based multi-spectral sensor depends strongly on the angular distribution of light hitting the filter on the detector array.

In general, in ambient light sensor systems, such a setup and the use of an (almost) Lambertion-type diffuser is expected to provide reliable relative measurement values between individual channels of the sensor, independently of the direction or angle of incoming light. Due to this reliable measurement of the respective spectral channel ratios, correct spectral reconstruction for proper characterization of incoming radiation will be possible, independently of the angle of irradiation. This per se will not be true, however, for measurement values for the total quantity of incoming radiation, or irradiance, or lux, which may depend strongly on the tilt angle of the respective device with respect to incoming radiation, in particular the so-called chief ray angle (“CRA”). This global value characteristic for the intensity of incoming light may be relevant for further signal processing, however, and the absolute value of irradiance detection will decrease by a cosine function for typical designs and layouts of the detector channels. In particular, typical wearable or handheld devices such as smart watches or mobile phones will tilt anytime and for applications in such devices the accuracy for Lux measurement etc will provide wrong output values.

### SUMMARY

The object of the invention is therefore to provide an improved optical measurement system of the type identified above, comprising an optical sensor with an array of detector elements or pixels, that helps overcome the deficiencies identified above. Further, an improved multispectral sensor should be provided, as well as an improved method for multi-spectral light sensing.

With respect to the optical detector unit, this object is achieved by providing a dedicated optical CRA detector unit comprising an optical sensor arranged in a chamber with an aperture in a housing, wherein the optical sensor comprises a number of CRA detector pixels having the same spectral sensitivity, each generating an irradiance sensor signal, and wherein the irradiance sensor signals generated by the CRA detector pixels are provided for generation of a parameter characteristic for the Chief Ray Angle (CRA) of the irradiance of the detector unit.

Preferred embodiments are subject of the dependent claims.

The invention is based on the consideration that in order to overcome the potential deficiencies identified above and to provide an ambient light sensor with improved performance, a dedicated CRA detector unit should be provided, preferably in addition to and in combination with a spectral detector unit. The CRA detector pixels, in order to properly and comparably refer to light intensity values, preferably all should have identical spectral sensitivity.

In a preferred embodiment, the CRA detector pixels are arranged in a sensor array within a basal plane defined by at least three of said CRA detector pixels. In yet another preferred embodiment, a number of said CRA detector pixels are located in an outskirt range of said sensor array and at least one of said CRA detector pixels is located in a central area of said sensor array, within said basal plane. In this setup, the central pixel may be used for reference, in order to properly and comparably identify variations in detected irradiance in the other pixels by comparison. Further, such central pixel will also facilitate identification of a point type source of radiation, and therefore significantly improve evaluation capacity of the system.

In yet another preferred embodiment, each of the CRA detector pixels located in the outskirt range of said sensor array is associated with at least one further of said CRA detector pixelsor “partner pixel” located in said outskirt range in an opposite position with respect to the centre of said sensor array. In such an arrangement, for any direction defined by such pair of pixels, a direct value for an irradiation angle may be determined by comparison or ratio of the respective sensor values.

In order to facilitate the measurement of the effects of tilt angle or angle of irradiation, in one important aspect of the invention considered independently inventive, the aperture of the CRA detector is designed smaller or narrower as compared to the lateral spread or dimension of the CRA sensor arrangement underneath. The aperture or aperture width in this context is understood to refer to the free aperture or its diameter through which the light rays are received by the sensor system underneath. This design principle will make sure that the respective CRA detector pixels are enabled to detect incoming radiation especially in the cases in which the direction of light is tilted with respect to the system and parts underneath the fringes of the aperture are irradiated. Preferably, the width of the aperture is smaller than the lateral size of the sensor arrangement. In a preferred embodiment, and in accordance with one aspect of the invention, the width of the aperture is chosen to be about 50% of the lateral size of the sensor arrangement. In a preferred embodiment, the width of the aperture may be about 200 μm while the lateral size of the sensor arrangement may be about 400 μm.

In a preferred embodiment, each of said CRA detector pixels (consists of a photon measurement unit, preferably a photodiode, only.

In another preferred embodiment, the CRA detector unit further comprises a measurement unit configured to provide sensor signals generated by the optical sensor, wherein said measurement unit is arranged to calculate said parameter characteristic for the Chief Ray Angle (CRA) based upon calculation of the ratio of irradiance sensor signals generated by any two of the CRA detector pixels.

With respect to the multispectral sensor system, the object mentioned above is achieved in that, in addition to and in combination with an optical CRA detector unit as described above, a spectral detector unit is provided, said spectral detector unit comprising an optical spectral sensor arranged in a second chamber with a spectral sensor aperture in a housing, and a spectral sensor diffuser arranged on top of said spectral sensor aperture, wherein the optical spectral sensor comprises an array of spectral sensor pixels, each having a different spectral transmission characteristic, and each generating a multispectral sensor signal, respectively.

In a preferred embodiment, said optical CRA detector unit comprises a CRA detector diffuser arranged on top of said aperture on said housing, wherein said CRA detector diffuser has lower scattering capability as compared to said spectral sensor diffuser. Preferably, the spectral sensor diffuser may be chosen to be of Lambertian type, whereas the scattering capability of the CRA detector diffuser is chosen such that the spread angle of this diffusor is about 10° to 40°, preferably between 20° and 40°.

In a preferred embodiment, the multispectral sensor system is designed as an ambient light sensor.

According to a preferred aspect of the invention, the pixels of the spectral sensor each comprise a photodiode as the basic photon detection device, and—other than the CRA detector pixels—an associated filter, wherein the filter determines the transmission characteristic of the respective sensor pixel.

With respect to the method for multispectral light sensing, the object identified above in accordance with one aspect of the invention is achieved with Method for light sensing, comprising the steps of:
detecting received photons by means of an optical sensor (arranged in a chamber of a housing through an aperture of said chamber,
wherein the optical sensor comprises a number of CRA detector pixels having the same spectral sensitivity,
for each CRA detector pixel generating an irradiance sensor signal, and
calculating a parameter characteristic for the Chief Ray Angle (CRA) of the irradiance of the detector unit.

In a preferred embodiment, the method further comprises the step of calculating said parameter characteristic for the Chief Ray Angle (CRA) based upon calculation of the ratio of irradiance sensor signals generated by any two of the CRA detector pixels.

In yet another preferred embodiment, the method for multi-spectral light sensing, in particular in the multispectral sensor system of the type described above, and using the steps of the method as described above, further comprises the steps of
detecting received photons by means of an optical spectral sensor arranged in a second chamber of a housing through a spectral sensor diffuser and through a spectral sensor aperture of said second chamber, wherein the optical spectral sensor comprises an array of spectral sensor pixels, each having a different spectral transmission characteristic,
for each spectral sensor pixel, generating a multispectral sensor signal, respectively,
calculating a modified multispectral sensor signal for each multispectral sensor signal by compensating the respective multispectral sensor signal using said parameter characteristic for the Chief Ray Angle (CRA), and
providing the modified multispectral sensor signals as output signals of the multispectral sensor system.

In one aspect the present invention also suggests a camera system, preferably in a smartphone or a wearable device, comprising an ambient light sensor having an optical detector unit of the type identified above.

The major advantages achieved by the invention may be seen in that due to the basic concept of the invention of providing a dedicated, separate CRA detector unit, preferably in addition to and combination with a spectral detector unit, allows for precise determination of the overall irradiance, thereby enabling to compensate for variations in irradiation due to tilt of the respective device. In particular, the concept of combining such dedicated CRA detector unit with a “conventional” spectral detector unit, in particular an ambient light sensor, detects the whole ambient light and generates a centroid of angle of incidence distribution (chief ray angle—CRA) that may be used for lux compensation. The spectral sensor system preferably is kept separate and may still use an ideal Lambertian diffuser to be independent of AOI distribution to the spectral reconstruction.

In other words, in one aspect the invention suggests the combination of a colour and/or spectral sensing part including an ideal diffuser for best performance in spectral reconstruction with an additional part in the same device that provides a value for the CRA to do a cosine Lux compensation in tilted use case conditions. In embodiments, a “slight” diffuser and detector array may be used in the CRA detector unit to obtain angular depending spread of irradiance on the sensor array. This spread on the detector array may then be analysed and used to estimate or approximate the mean AOI or CRA. From this, in turn, in case of respective systems, the cosine compensation factor=>ccf=1/cos(CRA) may be calculated in order to compensate all channel signals of the spectral sensor or only the output value (Lux or spectra).

Therefore, by the suggested combination of an accurate colour and spectral sensing for ambient light in the spectral sensor unit with an angular dependent Lux measurement in the CRA detector unit, a dynamic measurement of irradiance in wearables and mobile devices is possible as well as compensation of angular depending irradiance signals.

### BRIEF DESCRIPTION OF THE PREFERRED EMBODIMENTS

Preferred embodiments and aspects of the invention are described further in connection with a drawing. In this drawing,

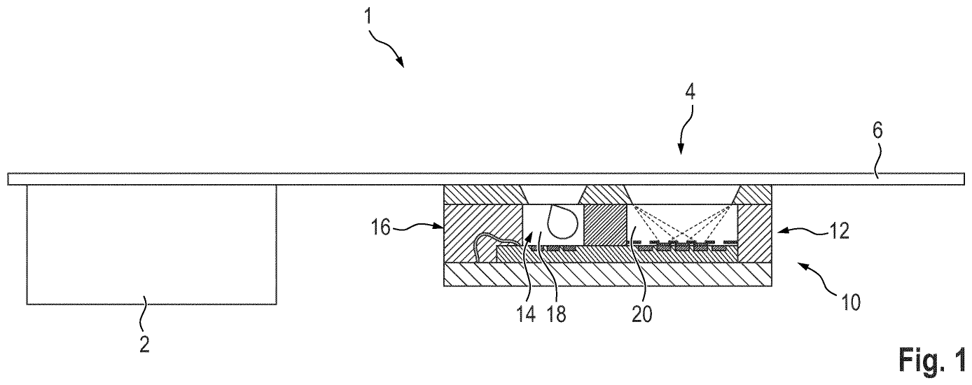

FIG. 1 shows a camera system, in particular for use in a smartphone,

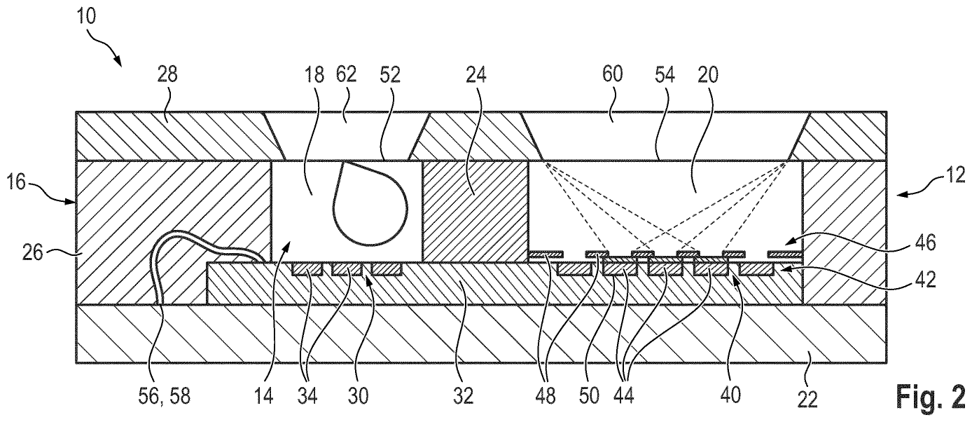

FIG. 2 shows a multispectral sensor system of the camera system of FIG. 1 in cross section;

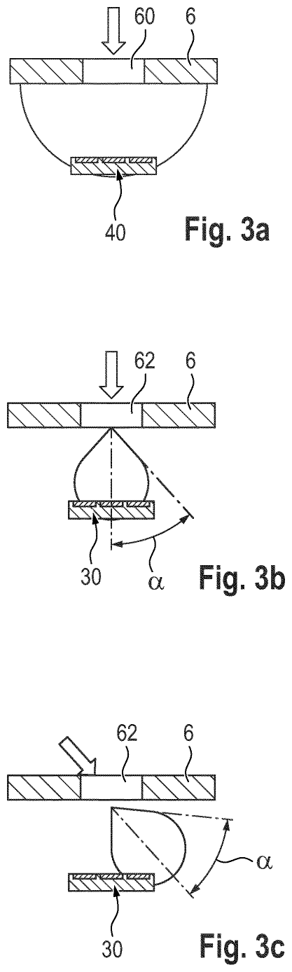

FIG. 3 schematically shows the radiation pattern of various embodiments of diffusers, and

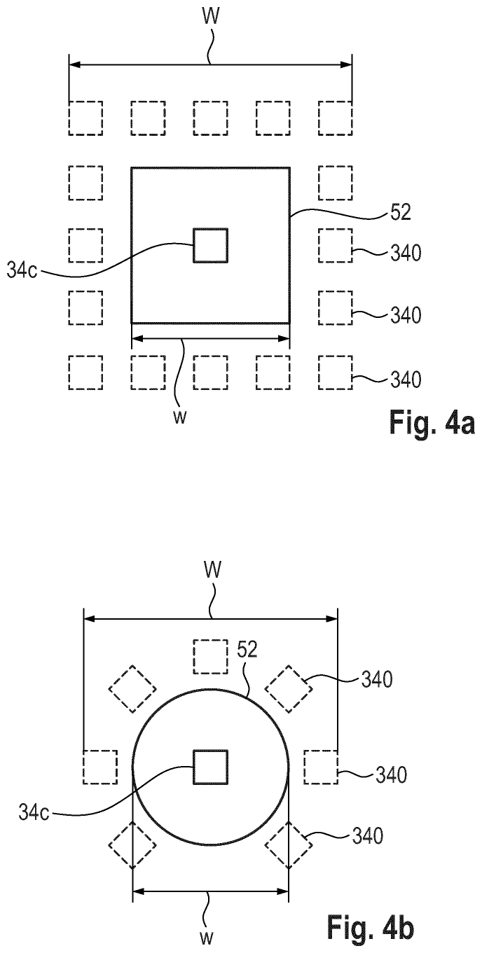

FIG. 4 shows embodiments of arrangements of sensor pixels of a CRA detector unit in top view.

Identical parts are labelled by the same reference numerals.

### DETAILED DESCRIPTION OF THE PREFERRED EMBODIMENTS

FIG. 1 shows an example of a camera system 1 in cross section that in the embodiment shown is integrated into a mobile device such as a smartphone. It is noted, however, that the concept presented below may very well be uses in other systems or devices, such as wearables. The camera system 1, as its major components, comprises the actual camera sensor system 2, the details of which are of lesser significance for the invention disclosed here, and an ambient light sensor 4 associated therewith. The camera sensor system 2 and the ambient light sensor 4 are mounted at the back of a common cover glass 6, which may be the cover glass 6 of the smartphone as such. The ambient light sensor 4 is used mainly for so-called “auto white balance” functionality in the camera system 1, in order to provide essential background information for appropriate correction functionalities and thereby in general improve imaging quality of the camera system 1.

The ambient light sensor 4 comprises a multispectral sensor system 10 in the form and design of an optical sensor chip. It is noted that the concept proposed herein can be applied for various types of optical sensor chips and optical devices and that the present invention relates to the design of the multispectral sensor system 10 alone and therefore, within the scope of the present invention, may very well be used in a multispectral sensor system 10 in other applications.

The multispectral sensor system 10, which is shown in FIG. 2 in enlarged cross section, comprises a spectral detector unit 12 of more or less conventional design. In general, colour and spectral sensors for ambient light measurement are using an ideal, “Lambertian” diffuser to generate constant angular distribution of light arriving at the detector array of such spectral detector unit 12. This provides accurate sensor signals for the ratios of individual spectral channels, and consequently proper and reliable spectral reconstruction is nearly independent from angular conditions in the object field. This may be not the case, however, for absolute values, of sensor signals, representing a value of total irradiance or lux, which may be significantly dependent on the angle of incidence of incoming light, which may vary depending on tilting the respective device depending on the current use case or user situation.

A source perpendicular to such detector will collect maximum light on its diffuser/aperture size. A tilt between source and detector generates less light on the same diffuser/aperture size. The absolute value of irradiance detection will decrease by a cosine function of the tilt angle. Wearables or handheld devices during use will tilt anytime and the accuracy for instance for Lux measurement will provide wrong or erroneous output values.

In order to complement for these deficiencies, in an embodiment of the present invention the multispectral sensor system 10 used for providing the ambient light sensor 4, in addition to and in combination with the spectral detector unit 12, comprises an optical Chief Ray Angle (CRA) detector unit 14. In the context of the present disclosure, the “chief ray angle” is to be understood as the angle between the optical axis of the respective unit 12, 14 and the axis of incoming irradiance from a dominant light source and therefore may also be understood to be the _{“}angle of incidence” of measured ambient light in the ambient light sensor 4. In accordance with one aspect of the invention, the CRA detector unit 14 is provided in combination with the spectral detector unit 12 of the multispectral sensor system 10 in order to provide compensation for changes of irradiating lux values as a consequence of varying tilt angles of the respective device, and in particular to compensate cosine error effects at tilted use cases for ambient colour and spectral sensing in the spectral detector unit 12.

As shown in FIG. 2, the multispectral sensor system 10 comprises an opaque housing 16 with two chambers: a first chamber 18 as part of the CRA detector unit 14 and a second chamber 20 as part of the spectral detector unit 12. The chambers 18, 20, functionally speaking, may be referred to as optical chambers 18,20. In the embodiment shown, however, the chambers 18, 20 are designed as “physical” chambers 18, 20 filled with air, or alternatively, filled with glass as substrate for the aperture. The opaque housing 16 is arranged on a substrate or carrier 22 and comprises a light barrier 24 which divides the housing 16 into the first and second chamber 18, 20 and therefore may be interpreted as the separation wall between spectral detector unit 12 and CRA detector unit 4. The first and second chambers 18, 20 are further confined laterally by a frame body 26 arranged in the housing 16. A cover section or lid 28, also part of the housing 16, is located opposite to the carrier 22 and thereby covers the chambers 18, 20. The cover section 28, the frame body 26, and the light barrier 24 may be manufactured from a continuous piece of material, such as a mold material, for example.

The carrier or substrate 22 provides mechanical support and electrical connectivity to electronic components which are integrated into the multispectral sensor system 10. For example, the carrier 22 comprises a printed circuit board, PCB (not shown). However, in other embodiments (not shown) the carrier 22 can also be part of the housing 16 and electronic components are embedded into the housing 16 by molding for example. In yet an alternative embodiment, the circuitry may be designed in TSV technology (“through silicon via”). A through-chip via is a vertical electrical connection (via) that passes completely through a silicon wafer or die. The contacting of the chip in this technology is brought to the backside of the chip and processed as a BGA (ball grid array). The advantage is that everything may be mounted at wafer level (Si, filter, glass, optic, aperture, diffuser . . . ).

As part of the CRA detector unit 14 of the multispectral sensor system 10, an optical sensor unit 30 is arranged inside the first chamber 18 and on the carrier 22. In the particular embodiment shown, the optical sensor unit 30 is integrated into a single semiconductor sensor die 32 together with other electronics. The optical sensor 30 comprises a number of individual optical detector elements or CRA detector pixels 34, having the same spectral sensitivity. The pixels 34 each con-sist of a photon measurement unit and in the embodiment shown are implemented as photodiodes, for example.

Further, as part of the spectral detector unit 12 of the multispectral sensor system 10, an optical spectral sensor 40 is arranged inside the second chamber 20 and on the carrier 22, also as part of the sensor die 32. The spectral sensor 40 is designed in a way of “conventional” spectral sensor for ambient light measurement and as such comprises an array 42 of spectral sensor pixels 44, each having a different spectral transmission characteristic, and each generating a multispectral sensor signal, respectively. The spectral sensor pixels 44, as well, may be implemented as photodiodes, for example.

As further part of the spectral detector unit 12, and other than in the CRA detector unit 14, an array 46 of optical filters 48 is arranged in the second chamber 20 above the optical spectral sensor 40. The array 46 of optical filters 48 is attached to the optical spectral sensor 40. The spectral sensor pixels 44 each are associated with an associated optical filter 48 having a different transmission characteristic. Together the pixels 44 and associated filter 48 form a channel 50 of the spectral detector unit 12. In this regard, the design of CRA detector pixels 34 differs since they are not associated or interaction with such filter elements; rather, they are “uncovered” by any such filters in the embodiment shown. The optical filters 48 may be interference filters such as an optical cut-off filter, bandpass, long or short pass filter, dielectric filters, plasmonic filters, meta structure filters, Fabry-Perot filters and/or polymer filters.

In order to allow for proper passage of light or radiation, the cover or lid 28 of the housing 16, in each of both subunits spectral detector unit 12 and CRA detector unit 14, is provided with a first aperture 52 for the CRA detector unit 14 and a second or spectral sensor aperture 54 for the spectral detector unit 12. The first and the second apertures 52, 54 are positioned above the optical sensor unit 30 and the optical spectral sensor 40, respectively. In fact, the apertures 52, 54 each lie within a field of view (FOV) of the optical sensor unit 30 and the optical spectral sensor 40, respectively. The field of view of the optical sensor 30, 40 includes all points in space from where, at least theoretically, light radiated from an external radiation or light source may traverse towards the respective optical sensor 30, 40, e.g. for a fixed detector position and orientation.

A control unit 56 and a measurement unit 58 are integrated into the semiconductor sensor die 32 alongside with the optical sensors 30, 40. The measurement unit 58 can be considered a control unit for the multispectral sensor system 10. For example, it provides ambient light sensor signals which are generated by the optical sensor system 10. The control unit 56 and measurement unit 58 may be implemented as control logic, state machines, microprocessor and the like. They may also comprise additional components such as analog-to-digital converters, time-to-digital converters, amplifiers which too are located in the semiconductor sensor die 32. The semiconductor die 32 may have a printed circuit board PCB providing electrical communication to the individual components of the multispectral sensor.

The multispectral sensor system 10 in the embodiment shown is intended to be used as an ambient light sensor system with enhanced accuracy and precision. To this regard, the spectral detector unit 12 is designed as a rather conventional spectral ambient light sensor system. Accordingly, the spectral detector unit 12 is provided with a spectral sensor diffuser 60 arranged on top of the second or spectral sensor aperture 54. The spectral sensor diffuser 60 is designed as an “ideal”, Lambertian diffuser generating constant angular distribution of light hitting the spectral sensor channels 50. This setup is expected to provide reliable relative measurement values between the channels 50, independently of the direction or angle of incoming light. Due to this reliable measurement of the respective spectral channel ratios, correct spectral reconstruction for proper characterization of incoming radiation will be possible, independently of the angle of irradiation. This per se will not be true, however, for measurement values for the total quantity of incoming radiation, or irradiance, or lux, which may depend strongly on the tilt angle of the respective device with respect to incoming radiation. This global value characteristic for the intensity of incoming light may be relevant for further signal processing, however, and the absolute value of irradiance detection will decrease by a cosine function for typical designs and layouts of the detector channels 50.

In order to be able to compensate for such changes, the optical CRA detector unit 14 is provided. In accordance with one aspect of the invention, each CRA detector pixel 34 is designed to generate an irradiance sensor signal. Since all CRA detector pixels 34 are designed for the same spectral sensitivity, and after proper calibration to eliminate differences from production process etc, comparison of the irradiance sensor signals provided by the CRA detector pixels 34 may be used for the generation of a parameter characteristic for the Chief Ray Angle (CRA) of the irradiance of the detector unit 12 or the _{“}angle of incidence” of measured ambient light in the ambient light sensor 4. This parameter may later be used for compensation or correction purposes for the signals generated by the spectral sensor unit 12. In the embodiment shown, the measurement unit 58 is arranged to calculate said parameter characteristic for the Chief Ray Angle (CRA) based upon calculation of the ratio of irradiance sensor signals generated by any two of the CRA detector pixels 44.

In order to allow for such determination of the angle of incidence, in one aspect of the invention the CRA detector unit 14, in particular with respect to the arrangement of the aperture 52 in relation to the sensor 30 positioned underneath, is designed such that information about the angle of incidence will reach the sensor system 30, rather than being eliminated as in the spectral detector unit 12 by its diffuser 60. For this purpose, and in accordance with an aspect of the present invention, the aperture 52 associated with the first chamber 18 is either not covered by any diffuser, or it may be equipped with a diffuser 62 with properties chosen appropriately, as shown in the embodiment.

For further explanation, FIG. 3 schematically shows the radiation patterns of various types and/or situations for the diffuser 60, 62. In an ideal system, as shown in FIG. 3a, and as chosen for the design of diffuser 60, the diffuser 60 should completely mix and rescatter light or radiation coming in through the cover glass 6, generating a semi-spherical (resulting in semi-circular shape in cross sectional view) radiation pattern 70a of so-called Lambertian shape. This _{“}ideal” radiation pattern 70a will result in laterally almost homogenous exposure of the sensor unit 40 underneath the diffusor 60, as desired for the design of spectral detector unit 12. In particular, in such an ideal system the sensor unit 40 would detect and be limited by the aperture 54 behind the diffuser 60. In real systems, however, deviations from such ideal behaviour must be expected, possibly due to imperfections in the diffusor 60, 62 or the surrounding components, or reduced diffusing characteristics in favour of increased transmittance, resulting in a more droplet shaped radiation pattern 70b as shown in FIG. 3b, or for dominant light sources irradiating from a tilt angle resulting in a radiation pattern 70c as shown in FIG. 3c. Obviously, in the latter two cases the impact of the incoming radiation on the sensor unit 30 underneath the diffusor 62 is laterally inhomogeneous as is desired for the design of the CRA detector unit 14.

Typically, for “real” diffusers the “diffuser performance”may be described by the spread angle a between the main direction of the radiation and the direction in which the transmitted amplitude is reduced to 50% of that in the main direction. In accordance with an aspect of the invention, the diffuser 62 provided for the CRA detector unit 14 is designed for a spread angle a between 10° and 40°. Accordingly, in accordance with one aspect of the invention, the CRA detector diffuser 62 has lower scattering capability as compared to the spectral sensor diffuser 60.

In an aspect of the invention, the CRA detector pixels 34 are arranged in a sensor array or structure within a basal plane defined by at least three of the CRA detector pixels 34, in particular the surface plane of the sensor die 32.

In yet another aspect of the invention, the CRA detector pixels 34 laterally are arranged in order to provide rich information potentially useable for determination of the angle of incidence. FIG. 4 shows, in two exemplary embodiments, the arrangement of the CRA detector pixels 34, together with the aperture 52 on top, in top view. CRA pixels 34 covered by the lid 28 are shown on broken lines, whereas CRA pixels 34 directly underneath the aperture 52 and therefore uncovered by the lid 28, are shown in solid lines. Therein, FIG. 4a shows a “square type” or rectangular configuration of the CRA detector pixels 34 together with a matching aperture 52 of square shape, whereas in the embodiment shown in FIG. 4b, the CRA detector pixels 34 are arranged in a circular configuration, in combination with an aperture 52 of circular shape.

In both embodiments shown, a number of the CRA detector pixels 34o are located in an outskirt range of said sensor array or arrangement, and at least one of the CRA detector pixels 34c is located in a central area of the sensor arrangement, directly underneath the central area of the aperture 52. In the embodiments shown, and in accordance with yet another aspect of the invention, the outer CRA detector pixels 34o are arranged pairwise in opposite positions relative to the center pixel 34c, such that relative differences in irradiation in the direction defined by such pairs of pixels 34o may be detected and evaluated easily. In other words, in the arrangements shown each of CRA detector pixels 34c located in the outskirt range of the sensor arrangement is associated with at least one further of the CRA detector pixels 34o located in the outskirt range in an opposite position with respect to the centre of the sensor arrangement.

In order to facilitate the measurement of the effects of tilt angle or angle of irradiation, in one aspect of the invention considered independently inventive, the aperture 52 is designed smaller or narrower as compared to the lateral spread or dimension of the sensor arrangement underneath, such that at least some of the outskirt pixels 34o are at least partly covered by the lid 28. This design principle will make sure that the respective CRA detector pixels 34o are enabled to detect incoming radiation especially in the cases in which the direction of light is tilted with respect to the system and parts underneath the fringes of the aperture 52 are irradiated (comparable to the situation shown in FIG. 3c). In other words, in this embodiment of the invention the width w of the aperture 52 is smaller than the lateral size W of the sensor arrangement. Depending on the basic geometry, the width w and lateral size W, for rectangular systems as shown in FIG. 4a, may be understood as the side length of the pattern, whereas in circular arrangements as shown in FIG. 4b, it may be understood as the diameter, respectively.

In a preferred embodiment, and in accordance with one aspect of the invention, the width w of the aperture 52 may be chosen to be about 50% of the lateral size W of the sensor arrangement. In a preferred embodiment, the width w of the aperture 52 may be about 200 μm while the lateral size W of the sensor arrangement may be about 400 μm.

In yet another embodiment of the invention, the CRA detector pixels 34 are positioned in a section of the sensor die 32 equipped with other electronic systems. Since the CRA detector sensor 30 requires relatively few individual sensor pixels 34 that may well be distributed over a relatively large area, free spaces in between may well be used to accommodate other components or electronic elements. In particular, relatively small pixels gaps in size of the aperture may be provided, and the pixels 34 can be distributed between other IC structures in the sensor die 32.

In operation of the multispectral sensor system 10, received photons are detected by means of the Chief Ray Angle detector unit 14 arranged in the chamber 18 of the housing 16 through the aperture 52 of the chamber 52. In reaction, the optical sensor 30 comprising the CRA detector pixels 34, for each CRA detector pixel 34, generates an irradiance sensor signal, and based upon these sensor signals, a parameter characteristic for the Chief Ray Angle (CRA) of the irradiance of the detector unit is calculated. In particular, and in accordance with one aspect of the invention, this parameter characteristic for the Chief Ray Angle (CRA) is calculated based upon calculation of the ratio of irradiance sensor signals generated by any two of the CRA detector pixels 34.

Further received photons also are detected by means of the optical spectral sensor unit 12 arranged in the second chamber 20 of the housing 16 through the spectral sensor diffuser 60 and through the spectral sensor aperture 54 of the second chamber 20. For each spectral sensor pixel 44 of the optical spectral sensor 40, each having a different spectral transmission characteristic, a multispectral sensor signal is generated, and a modified multispectral sensor signal is calculated for each multispectral sensor signal by compensating the respective multispectral sensor signal using said parameter characteristic for the Chief Ray Angle (CRA), and the modified multispectral sensor signals are provided as output signals of the multispectral sensor system.

The embodiments of the optical sensor device 1 discussed herein have been disclosed for the purpose of familiarizing the reader with novel aspects of the idea. Although preferred embodiments have been shown and described, many changes, modifications, equivalents and substitutions of the disclosed concepts may be made by one having skill in the art without unnecessarily departing from the scope of the claims.

In particular, the disclosure is not limited to the disclosed embodiments, and gives examples of as many alternatives as possible for the features included in the embodiments discussed. However, it is intended that any modifications, equivalents and substitutions of the disclosed concepts be included within the scope of the claims which are appended hereto.

Features recited in separate dependent claims may be advantageously combined. Moreover, reference signs used in the claims are not limited to be construed as limiting the scope of the claims.

Furthermore, as used herein, the term “comprising” does not exclude other elements. In addition, as used herein, the article “a” is intended to include one or more than one component or element, and is not limited to be construed as meaning only one.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

### LIST OF REFERENCE NUMERALS

1 camera system
2 camera detection system
4 ambient light sensor
6 cover glass
10 multispectral sensor system
12 spectral detector unit
14 Chief Ray Angle detector unit
16 housing
18, 20 optical chamber
22 substrate
24 light barrier
26 frame body
28 lid
30 sensor unit
32 sensor die
34 CRA detector pixel
40 spectral sensor
42 array
44 spectral sensor pixel
46 array
48 optical filter
50 channel
52 aperture
54 spectral sensor aperture
56 control unit
58 measurement unit
60 spectral sensor diffuser
62 diffuser
70 radiation pattern
w width of aperture
W lateral size

1. An optical chief ray angle detector unit comprising an optical sensor arranged in an optical chamber with an aperture in a housing, wherein the optical sensor comprises a number of chief ray angle detector pixels having the same spectral sensitivity, each generating an irradiance sensor signal, and wherein the irradiance sensor signals generated by the chief ray angle detector pixels are provided for generation of a parameter characteristic for the chief ray angle of the irradiance of the detector unit.

2. The optical chief ray angle detector unit of claim 1, wherein said chief ray angle detector pixels are arranged in a sensor array within a basal plane defined by at least three of said chief ray angle detector pixels.

3. The optical chief ray angle detector unit of claim 2, wherein a number of said chief ray angle detector pixels are located in an outskirt range of said sensor array and at least one of said chief ray angle detector pixels is located in a central area of said sensor array, within said basal plane.

4. The optical chief ray angle detector unit of claim 3, wherein each of said chief ray angle detector pixels located in said outskirt range of said sensor array is associated with at least one further of said chief ray angle detector pixels located in said outskirt range in an opposite position with respect to the centre of said sensor array.

5. The optical chief ray angle detector unit of claim 2, wherein the aperture width (w) of said aperture is smaller than the lateral size (W) of said sensor array in said basal plane.

6. The optical chief ray angle detector unit of claim 1, wherein each of said chief ray angle detector pixels consists of a photon measurement unit.

7. The optical chief ray angle detector unit of claim 1, further comprising a measurement unit configured to provide sensor signals generated by the optical sensor, wherein said measurement unit is arranged to calculate said parameter characteristic for the Chief Ray Angle (CRA) based upon calculation of the ratio of irradiance sensor signals generated by any two of the CRA detector pixels.

8. A multispectral sensor system, comprising an optical chief ray angle detector unit of claim 1 and a spectral detector unit, said spectral detector unit comprising an optical spectral sensor arranged in a second optical chamber with a spectral sensor aperture in said housing, and a spectral sensor diffuser arranged on top of said spectral sensor aperture, wherein the optical spectral sensor comprises an array of spectral sensor pixels, each having a different spectral transmission characteristic, and each generating a multispectral sensor signal, respectively.

9. The multispectral sensor system of claim 8, in which said optical chief ray angle detector unit comprises a chief ray angle detector diffuser arranged on top of said aperture on said housing, wherein said chief ray angle detector diffuser has lower scattering capability as compared to said spectral sensor diffuser.

10. The multispectral sensor system of claim 8, which is designed as an ambient light sensor.

11. A method for light sensing, comprising the steps of:
detecting received photons by means of an optical sensor arranged in a chamber of a housing through an aperture of said chamber,
wherein the optical sensor comprises a number of chief ray angle detector pixels having the same spectral sensitivity,
for each CRA detector pixel, generating an irradiance sensor signal, and
calculating a parameter characteristic for the chief ray angle of the irradiance of the detector unit type.

12. The method of claim 11, further comprising the step of calculating said parameter characteristic for the chief ray angle based upon calculation of the ratio of irradiance sensor signals generated by any two of the chief ray angle detector pixels.

13. A method for multispectral light sensing, in particular in the multispectral sensor system of claim 8, further comprising the steps of:
detecting received photons by means of an optical spectral sensor arranged in a second chamber of a housing through a spectral sensor diffuser and through a spectral sensor aperture of said second chamber, wherein the optical spectral sensor comprises an array of spectral sensor pixels, each having a different spectral transmission characteristic,
for each spectral sensor pixel, generating a multispectral sensor signal, respectively,
calculating a modified multispectral sensor signal for each multispectral sensor signal by compensating the respective multispectral sensor signal using said parameter characteristic for the chief ray angle; and
providing the modified multispectral sensor signals as output signals of the multispectral sensor system.

14. The method of claim 11 in an application for ambient light sensing in camera applications or applications for wearables.

15. A camera system comprising an ambient light sensor having the optical chief ray angle detector unit of claim 1.
